(19) United States
(12) Patent Application Publication
(10) Pub. No.: US 2009/0036566 A1
(43) Pub. Date: Feb. 5, 2009

(54) BIODEGRADABLE COMPOSITE, PRODUCT MADE THEREFROM, AND METHOD OF MANUFACTURE THEREOF

(75) Inventors: Kwok Yiu LI, Kowloon (HK); Qiang ZHAO, Tianjin (CN); China Man YAM, Tuen Mun (HK); Mount Tsun Dominic MAK, Kowloon (HK)

Correspondence Address: HESLIN ROTHENBERG FARLEY & MESITI PC, 5 COLUMBIA CIRCLE, ALBANY, NY, 12203, US

(73) Assignee: CITY UNIVERSITY OF HONG KONG, Kowloon (HK)

(21) Appl. No.: 11/830,527

(22) Filed: Jul. 30, 2007

(51) Int. Cl. C08K 13/00

(52) U.S. Cl. 523/128

(57) ABSTRACT

Biodegradable composites and products, and methods of their manufacture are presented. The composites typically comprise 10 wt % to 80 wt % of a lignocellulosic material derived from an agricultural residue or obtained from a natural source, 20 wt % to 80 wt % of a polymer binder, 5 wt % to 20 wt % of a compatibilizer, and an effective amount of a processing aid. One method of manufacture of a product is by injection molding.

### FIELD OF THE INVENTION

The present invention relates to biodegradable composites and methods of manufacture thereof The present invention also relates to products made from such composites and methods of their manufacture.

### BACKGROUND OF THE INVENTION

Environmental pollution caused by accumulation of plastic waste, also known as “white pollution” has become increasingly serious throughout the world. Specifically, this plastic waste contributes to a large percentage of the landfill. It is estimated that it will take over 100 years for this plastic waste to degrade in the landfill. Due to this problem, there is an increasing demand of novel materials for making products, which either can be recycled or are biodegradable at least to some extent. Further, many products nowadays are made from plastic(s), which are converted from petroleum resources. Due to the scare supply of petroleum resources, there is a demand for a substitute material, which can at least partly replace conventional plastic(s) material.

There have been proposals in using degradable materials such as starch, natural fiber, and biodegradable polyester blended with conventional polymers for producing composites, which are more biodegradable. While this could solve part of the problem, the incorporation of these degradable materials often dramatically increases the cost of production to a point where it is generally commercially unjustifiable. Further, these conventional composites are limited in the way they can be used in production. For example, products from conventional composites are mainly manufactured by the compression, extrusion, or other molding methods, which often cannot provide products with complicated shape and structure. Meanwhile, continuous streamlined production process cannot be performed. Yet further, products made from these conventional ingredients often lack sufficient specification in order to fulfill the physical durability requirement.

A need exists for biodegradable composites, products made from such composites, and methods of manufacture thereof that overcomes at least one of the foregoing deficiencies.

### SUMMARY OF THE INVENTION

An aspect of the present invention relates to a composite comprising: (a) 10 percent by weight (wt %) to 80 wt % of a lignocellulosic material derived from an agricultural residue or obtained from a natural source; (b) 20 wt % to 80 wt % of a polymer binder; (c) 5 wt % to 20 wt % of a compatibilizer; and (d) an effective amount of a processing aid.

A second aspect of the present invention relates to a method of making a composite comprising: (a) drying a lignocellulosic agricultural material derived from an agricultural residue or obtained from a natural source; (b) mixing said dried lignocellulosic agricultural material with a polymer binder, a compatibilizer, and a processing aid resulting in the formation of a homogeneous mixture; and (c) introducing said homogeneous mixture into a twin-screw extruder resulting in the formation of said composite.

A third aspect of the present invention relates to a method of manufacturing an injection molded product comprising: (a) introducing a composite as described above to an injection molding machine for processing; and (b) obtaining said injection molded product from said injection molding machine.

A fourth aspect of the present invention relates to a method of manufacturing an injection molded product comprising: (a) preparing a composite according to the method described above; (b) introducing said composite into an injection molding machine for processing; and (c) obtaining said injection molded product from said injection molding machine.

### BRIEF DESCRIPTION OF THE DRAWINGS

FIG. 1 is a representation of a first product manufactured by injection molding and made from a composite material, in accordance with the present invention;

FIG. 2 is a representation of a second product manufactured by injection molding and made from a composite material, in accordance with the present invention; and

FIG. 3 is a representation of a third product manufactured by injection molding and made from a composite material, in accordance with the present invention.

### DETAILED DESCRIPTION OF THE INVENTION

Embodiments of the present invention will now be described with reference to the accompanying drawings,

According to an embodiment of the present invention, there is provided a composite comprising 10 percent by weight (wt %) to 80 wt % of a lignocellulosic material derived from an agricultural residue or obtained from a natural source, 20 wt % to 80 wt % of a polymer binder, and 5 wt % to 20 wt % of a compatibilizer. The composite may additionally comprise processing aids. In one embodiment, the composite may be essentially free of polycarbonate.

The lignocellulosic material may be selected from a group including rice husk, wheat straw, bagasse, corn stalk, sweet sorghum stalk, corncob, alfalfa, cotton stalk, peanut shell, bean stalk, and a combination thereof The polymer binder may be selected from a group including high-density polyethylene (HDPE), low-density polyethylene (LDPE), polypropylene (PP), polystyrene (PS), polyvinyl chloride (PVC), polyamide (PA), polyethylene terephthalate (PET), and a combination thereof The compatibilizer may be selected from a group including maleic anhydride grafted polyethylene (PE-g-MA), maleic anhydride grafted polystyrene (PS-g-MA), maleic anhydride grafted polypropylene (PP-g-MA), methacrylic acid grafted polypropylene, fumaric acid grafted polypropylene, acrylic acid grafted polypropylene, maleic anhydride grafted styrene-ethylene/butylene-styrene triblock polymer (SEBS-g-MA), methacrylic acid grafted styrene-ethylene/butylene-styrene triblock polymer, fumaric acid grafted styrene-ethylene/butylene-styrene triblock polymer, acrylic acid grafted styrene-ethylene/butylene-styrene triblock polymer, elastomeric ethylene-propylene copolymer grafted with styrene acrylonitrile (EPR-g-SAN), styrene-methyl methacrylate block copolymer (PS-b-PMMA, SMMA), styrene-acrylonitrile block copolymer (PS-b-PAN, SAN), and a combination thereof

The lignocellulosic material acts as a filler and the polymer binder acts as a binding agent. The compatibilizer improves the bonding between the filler and the polymer matrix, and thus improves the mechanical properties of products made from the composite material. In an embodiment of the present invention, the composite may comprise 1 wt % to 3 wt % of the processing aids. This may include a dispersion agent, a stabilizing agent and a pigment. The actual amount of the processing aids used will depend on the amount of the lignocellulosic material, the polymer binder, and the compatibilizer used. It will be apparent to those skilled in the art the amount of the processing aids to be used. Typically, the composite comprises 0.1 wt % to 1 wt % of the dispersion agent. An example of the dispersion agent is a dispersion oil.

In another embodiment, the composite may additionally comprise 0.01 wt % to 0.2 wt % of the stabilizing agent for improving stability of the composite or products made therefrom in the presence of ultraviolet light. The stabilizing agent may be selected from a group including hindered amine, benzophenone, benzotriazole, cyanoacrylate, benzoates, nickel organic, zinc compound, and a combination thereof.

In another embodiment, the composite material may additionally comprise 0.5 wt % to 2 wt % of a pigment. The pigment may be selected from the group consisting of a soluble polymer colorant, aluminum pigment, titanium dioxide, organic pigment, and a combination thereof The organic pigment may be selected from a group consisting of anthraquinone, benzimidazolone, diazo pigments, diketo pyrrolo pyrrole (DPP), dioxazine, isoindolinone, phthalocyanine, quinacridone, and a combination thereof

The composite material may additionally comprise 1 wt % to 10 wt % of inorganic filler selected from a group consisting of glass fiber, alumina, zinc oxide, silica, calcium carbonate, montmorillonite, and a combination thereof. The composite may be injection moldable for forming an article of product.

As explained above, conventional composites (also known as composite materials) suffer from a number of disadvantages. The present invention seeks to provide an alternative composite (also known as eco-composite or ecocomposite) which, when compared with conventional non-biodegradable materials, may be more easily biodegradable, and yet the composite materials are not limited to being processed by compression molding or extrusion, and can be subjected to the processing method of injection molding. Tn one embodiment, the extruded composite material can be granulated into pelletes. Products made from these composite materials include tableware, containers, toy products, household products, etc.

One main ingredient of such an eco-composite material in an embodiment of the present invention is agricultural residue. There are a variety of agricultural residues which may be used. They include but are not limited to rice husk, wheat straw, bagasse, corn stalk, sweet sorghum stalk, corncob, alfalfa, cotton stalk, peanut shell, and bean stalk. All of which share a characteristic of having a high lignocellulose content and are obtainable from a natural source. A mixture of different agricultural residues may be used in the same eco-composite.

Another main ingredient of the eco-composite material is a polymer binder, which serves as a binding agent. While the polymer binder ingredient by itself may not be readily biodegradable, but it only contributes to a fraction of the overall ingredients, products made from the eco-composite material are readily biodegradable compared to other products made from entirely non-biodegradable resins. One role of the polymer binder ingredient is that it can improve the integrity of the ingredients. Further, it will improve the general texture, durability, and specification of the products made. Yet further, the inclusion of the polymer binder in the ingredients allows the composite materials be meltable or processable, e.g., injection moldable effectively and in practice. Examples of polymer binder, which may be used with present invention, are high-density polyethylene (HDPE), low-density polyethylene (LDPE) polypropylene (PP), polystyrene (PS), polyvinyl chloride (PVC), polyamide (PA), and polyethylene terephthalate (PET).

Another main ingredient of the eco-composite material is the compatibilizer. One main function of the compatibilizer is to enhance the compatibility between the lignocellulosic filler and the polymer matrix in the ecocomposite materials such that they can be mixed together more coherently. Examples of compatibilizer which may be used include maleic anhydride grafted polyethylene (PE-g-MA), maleic anhydride grafted polystyrene (PS-g-MA), maleic anhydride grafted polypropylene (PP-g-MA), methacrylic acid grafted polypropylene, fumaric acid grafted polypropylene, acrylic acid grafted polypropylene, maleic anhydride grafted styrene-ethylene/butylene-styrene triblock polymer (SEBS-g-MA), methacrylic acid grafted styrene-ethylene/butylene-styrene triblock polymer, fumaric acid grafted styrene-ethylene/butylene-styrene triblock polymer, acrylic acid grafted styrene-ethylene/butylene-styrene triblock polymer, elastomeric ethylene-propylene copolymer grafted with styrene acrylonitrile (EPR-g-SAN), styrene-methyl methacrylate block copolymer (PS-h-PMMA, SMMA), and styrene-acrylonitrile block copolymer (PS-h-PAN, SAN).

Other optional ingredients may also be added to the composite material. Examples include but are not limited to inorganic fillers, pigments, dispersion oils, and stabilizers. The dispersion oils may be added to assist the dispersion of pigments.

Experiments have been performed to produce eco-composite materials in accordance with the present invention. The results are as follow.

### EXPERIMENTAL

### EXAMPLE 1

An eco-composite material was successfully prepared according to the following formulation.

TABLE 1
Composition of the eco-composite prepared in this work

| | Content in weight |
|---|---|
| Component | percentage (wt %) |
| Rice Husk | 60 |
| High-density polyethylene (HDPE) | 25.8 |
| Inorganic fillers | 2 |
| Maleic anhydride grafted polyethylene | 11 |
| (PF-g-MA) | |
| Pigment | 0.9 |
| Dispersion oil | 0.2 |
| Stabilizer in UV light | 0.1 |

The above eco-composite material was then tested for its physical properties. The result of the test was as follows.

TABLE 2
Physical properties of the eco-composites prepared in this work.

| Properties | Test Standard | Value |
|---|---|---|
| Two-hour Boiling Water Immersion | ASTM D570-98 | 4.72 ± 0.77% |
| Twenty-Four Hour Immersion (23° C.) | ASTM D570-98 | 1.10 ± 0.24% |
| Immersion at 50° C. (two days) | ASTM D570-98 | 3.85 ± 0.06% |
| Modulus of Elasticity (Flexural) | ASTM D790-03 | (2.62 ± 0.16) × 10³ MPa |
| Impact Resistance | ASTM D256-06 | 19.2 ± 0.5 J/m |
| | | (1.89 ± 0.04) × 10³ J/m² |
| Modulus of Elasticity (Tensile) | ASTM D638-03 | (2.73 ± 0.09) × 10³ MPa |
| Tensile stress at break | ASTM D638-03 | 24.9 ± 0.2 Mpa |
| Percent elongation at break | ASTM D638-03 | 2.60 ± 0.13% |

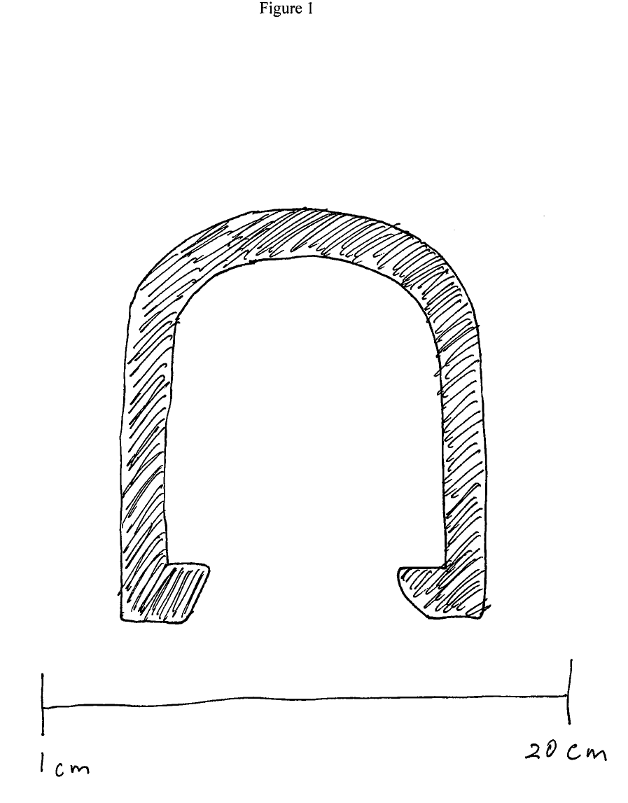

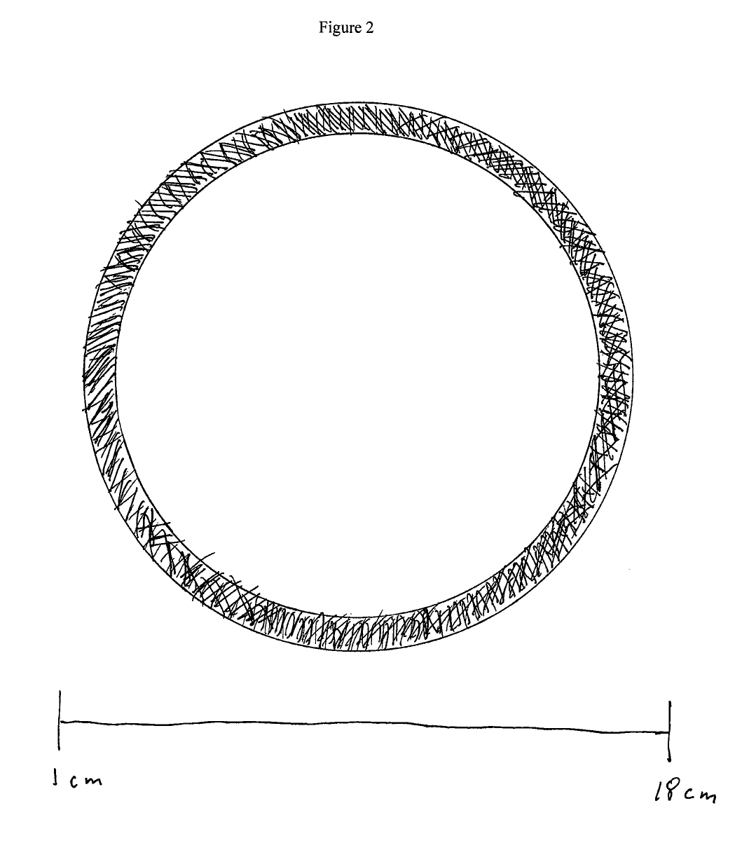

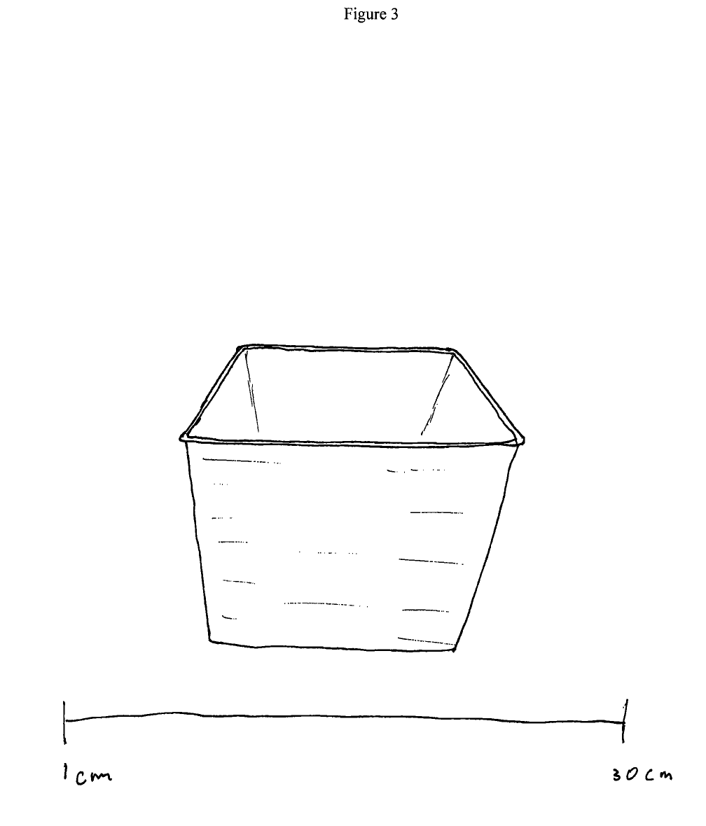

The values measured after immersion of the eco-composite materials reflect the water resistance of the materials. The lower the value the more favorable the material is in practical use. The above eco-composite material was then subjected to injection molding for producing various products. Three of the products are described in FIGS. 1 to 3. It is to be noted from the Figures show that these injection molded products have fairly fine surface finishing.

### EXAMPLE 2

Another eco-composite material was successfully prepared according to the following formulation.

TABLE 3
Composition of the eco-composite prepared in this work

| | Content in weight |
|---|---|
| Component | percentage (wt %) |
| Rice Husk | 30 |
| polypropylene (PP) | 44 |
| Inorganic fillers | 10 |
| Maleic anhydride grafted polyethylene | 15 |
| (PE-g-MA) | |
| Pigment | 0.6 |
| Dispersion oil | 0.3 |
| Stabilizer in UV light | 0.1 |

The above eco-composite was then tested for its physical properties. The result of the test was as follows.

TABLE 4
Physical properties of the eco-composite prepared in this work

| Properties | Test Standard | Value |
|---|---|---|
| Twenty-Four Hour Immersion (23° C.) | ASTM D570-98 | 1.14% |
| Modulus of Elasticity (Flexural) | ASTM D790-03 | (1.98 ± 0.14) × 10³ MPa |
| Impact Resistance | ASTM D256-06 | (3.78 ± 0.42) × 10³ J/m² |
| Modulus of Elasticity (Tensile) | ASTM D638-03 | (2.34 ± 0.13) × 10³ MPa |
| Tensile stress at break | ASTM D638-03 | 33.7 ± 0.2 Mpa |
| Percent elongation at break | ASTM D638-03 | 3.09 ± 0.15% |

### EXAMPLE 3

Yet another eco-composite material was successfully prepared according to the following formulation.

TABLE 5
Composition of the eco-composite prepared in this work

| | Content in weight |
|---|---|
| Component | percentage (wt %) |
| Rice Husk | 20 |
| High-density polyethylene (HDPE) | 75 |
| Inorganic fillers | 0 |
| Maleic anhydride grafted polyethylene | 4 |
| (PE-g-MA) | |
| Pigment | 0.7 |
| Dispersion oil | 0.2 |
| Stabilizer in UV light | 0.1 |

The above eco-composite was then tested for its physical properties. The result of the test was as follows.

TABLE 6
Physical properties of the eco-composite

| Properties | Test Standard | Value |
|---|---|---|
| Two-hour Boiling Water Immersion | ASTM D570-98 | 0.498 ± 0.058% |
| Twenty-Four Hour Immersion (23° C.) | ASTM D570-98 | 0.218 ± 0.064% |
| Immersion at 50° C. (two days) | ASTM D570-98 | 0.503 ± 0.001% |
| Modulus of Elasticity (Flexural) | ASTM D790-03 | (1.71 ± 0.13) × 10³ MPa |
| Impact Resistance | ASTM D256-06 | 26.5 ± 2.1 J/m |
| | | (2.64 ± 0.22) × 10³ J/m² |
| Modulus of Elasticity (Tensile) | ASTM D638-03 | (1.38 ± 0.03) × 10³ MPa |
| Tensile stress at break | ASTM D638-03 | 23.5 ± 0.2 Mpa |
| Percent elongation at break | ASTM D638-03 | 7.52 ± 0.32% |

In addition to the examples described above, further studies had been peformed to show that the eco-composite may have a content of agricultural residue from as low as 10 wt % to as high as 80 wt % and the resultant composite material or products made therefrom can exhibit physical properties that still suit a variety of products in practice. In this connection, the content of polymer binder may be in a range from 20 wt % to 80 wt % and the content of compatibilizer may be in a range from 5 wt % to 20 wt %.

The method of manufacturing an eco-composite in accordance with the present invention is as follows. All the ingredients are firstly obtained. The agricultural residue is then dried. This is typically done by drying the ingredients in an oven at 60 to 110° C. for 24 hours. All the ingredients are then dry mixed thoroughly until they become homogenous. The mixed ingredients are then subjected to a one-step compounding procedure in a twin-screw extruder (or the like). The compounded materials are subsequently extruded and then finally granulated to pellets.

This one-step procedure is to be contrasted with the process of manufacture of for example conventional biodegradable composites in that they are typically prepared by multi-step procedures, which are necessarily more complicated and costly, and cannot realize continuously streamlined production.

The eco-composite material obtained from the above method is fed into an injection molding machine under suitable conditions. Different injection molding machines (e.g. conventional injection molding machine, and powder injection molding machine, etc.) or different adjustments to the machine may be needed when the eco-composite with different contents of ingredients or ingredients are used.

It is to be noted that products made from the eco-composite material according to the present invention are injection molded. The products may be in two-dimensional form or in sheet-form. Alternatively, the products may be formed into three-dimensional form and no pre/post-punching step may be required—the three-dimensional products may be formed straight into their final form. Complicated two/three dimensional structures can be made by injection molding.

1. A composite comprising:
(a) 10 percent by weight (wt %) to 80 wt % of a lignocellulosic material derived from an agricultural residue or obtained from a natural source;
(b) 20 wt % to 80 wt % of a polymer binder;
(c) 5 wt % to 20 wt % of a compatibilizer; and
(d) 1 wt % to 3 wt % of a processing aid;

2. A composite according to claim 1, wherein said lignocellulosic material is selected from the group consisting of rice husk, wheat straw, bagasse, corn stalk, sweet sorghum stalk, corncob, alfalfa, cotton stalk, peanut shell, bean stalk, and combinations thereof.

3. A composite according to claim 1, wherein said polymer binder is selected from the group consisting of high-density polyethylene (HDPE), low-density polyethylene (LDPE) polypropylene (PP), polystyrene (PS), polyvinyl chloride (PVC), polyamide (PA), polyethylene terephthalate (PET), and combinations thereof.

4. A composite according to claim 1, wherein said compatibilizer is selected from the group consisting of maleic anhydride grafted polyethylene (PE-g-MA), maleic anhydride grafted polystyrene (PS-g-MA), maleic anhydride grafted polypropylene (PP-g-MA), methacrylic acid grafted polypropylene, fumaric acid grafted polypropylene, acrylic acid grafted polypropylene, maleic anhydride grafted styrene-ethylene/butylene-styrene triblock polymer (SEBS-g-MA), methacrylic acid grafted styrene-ethylene/butylene-styrene triblock polymer, fumaric acid grafted styrene-ethylene/butylene-styrene triblock polymer, acrylic acid grafted styrene-ethylene/butylene-styrene triblock polymer, elastomeric ethylene-propylene copolymer grafted with styrene acrylonitrile (EPR-g-SAN), styrene-methyl methacrylate block copolymer (PS-b-PMMA, SMMA), styrene-acrylonitrile block copolymer (PS-b-P AN, SAN), and combinations thereof.

5. (canceled)

6. A composite according to claim 1, wherein said processing aid is selected from the group consisting of a dispersion agent, a stabilizing agent, and a pigment.

7. A composite according to claim 6, wherein said dispersion agent comprises is from 0.1 wt % to 1 wt % of said composite.

8. A composite as claimed in claim 6, wherein said dispersion agent is a dispersion oil.

9. A composite as claimed in claim 6, wherein said stabilizing agent comprises from 0.01 wt % to 0.2 wt % of said composite.

10. A composite according to claim 6, wherein said stabilizing agent is selected the group consisting of a hindered amine, benzophenone, benzotriazole, cyanoacrylate, benzoate, nickel organic, a zinc compound, and combinations thereof.

11. A composite according to claim 6, wherein said pigment comprises from 0.5 wt % to 2 wt % of said composite.

12. A composite according to claim 6, wherein said pigment is selected from the group consisting of a soluble polymer colorant, aluminum pigment, titanium dioxide, an organic pigment, and combinations thereof.

13. A composite according to claim 6, wherein said organic pigment is selected from the group consisting of anthraquinone, benzimidazolone, diazo pigments, diketo pyrrolo pyrrole (DPP), dioxazine, isoindolinone, phthalocyanine, quinacridone, and combinations thereof.

14. A composite according to claim 1, additionally comprising from 1 wt % to 10 wt % of an inorganic filler selected from the group consisting of glass fiber, alumina, zinc oxide, silica, calcium carbonate, montmorillonite, and combinations thereof.

15. A composite according to claim 1, wherein said composite can be injection molded to form at least one of an article or product.

16. A product comprising a composite according to claim 1.

17. A method of making a composite comprising 60 wt % to 80 wt % of a lignocellulosic material derived from an agricultural residue or obtained from a natural source, comprising:
(a) drying said lignocellulosic agricultural material;
(b) mixing said dried lignocellulosic agricultural material with a polymer binder, a compatibilizer, and a processing aid resulting in the formation of a homogeneous mixture; and
(c) introducing said homogeneous mixture into a twin-screw extruder resulting in the formation of said composite.

18. A method of manufacturing an injection molded product comprising:
(a) introducing a composite according to claim 1 to an injection molding machine for processing; and
(b) obtaining said injection molded product from said injection molding machine.

19. A method of manufacturing an injection molded product comprising:
(a) preparing a composite according to the method of claim 17;
(b) introducing said composite into an injection molding machine for processing; and
(c) obtaining said injection molded product from said injection molding machine.

20. A product manufactured by a method according to any of claims 18 and 19.

21. A composite according to claim 1, wherein said composite comprises 60 wt % to 80 wt % of a lignocellulosic material derived from an agricultural residue or obtained from a natural source.
